(19) United States
(12) Patent Application Publication
(10) Pub. No.: US 2009/0048140 A1
(43) Pub. Date: Feb. 19, 2009

(54) Coated Imidoperoxycarbonate Acid Particle

(75) Inventors: Peter Schmiedel, Duesseldorf (DE); Wolfgang Von Rybinski, Duesseldorf (DE); Heribert Kaiser, Duesseldorf (DE); Matthias Sunder, Duesseldorf (DE); Soeren Hoelsken, Duesseldorf (DE); Bernhard Guckenbiehl, Cologne (DE)

Correspondence Address: Ratner Prestia, Suite 301, 1235 Westlakes Drive, Berwyn, PA, 19312, US

(73) Assignee: Henkel AG & Co. KGaA, Duesseldorf (DE)

(21) Appl. No.: 12/254,362

(22) Filed: Oct. 20, 2008

Related U.S. Application Data
(63) Continuation of application No. PCT/EP2007/053359, filed on Apr. 5, 2007.

(30) Foreign Application Priority Data
Apr. 19, 2006 (DE) 10 2006 018 344.4

(51) Int. Cl. C11D 17/00

(52) U.S. Cl. 510/418

(57) ABSTRACT

A particle-shaped imidoperoxycarbonate acid with a paraffin sheath. The imidoperoxycarbonate acid remains stable when mixed into a hydrous liquid washing and cleaning substance.

### CROSS REFERENCE TO RELATED APPLICATIONS

This application is a continuation under 35 U.S.C. §§ 120 and 365(c) of International Application PCT/EP2007/053359, filed on Apr. 5, 2007. This application also claims priority under 35 U.S.C. § 119 of DE 10 2006 018 344.4 filed on Apr. 19, 2006. The disclosures of PCT/EP20071053359 and DE 10 2006 018 344.4 are incorporated by reference in their entirety.

### BACKGROUND OF THE INVENTION

The present invention relates to coated particles comprising imidoperoxocarboxylic acid in their core and having a coating of paraffin wax as well as methods of making and using them to produce liquid aqueous detergents and cleaning agents.

With detergents and cleaning agents in liquid form, in particular when they contain water but also when they are anhydrous, ingredients may interact negatively with one another because of chemical incompatibility of the individual ingredients, and there may be a decline in their activity and thus a decline in washing performance of the agent as a whole, even if stored for only a relatively short period of time. The decline in activity relates in principle to all detergent ingredients that react chemically in the washing process to contribute to the washing result, in particular bleaching agents and enzymes, although surfactant ingredients or sequestering ingredients, which are responsible for solution processes or complexing steps, do not have unlimited stability in storage, in particular in the presence of the aforementioned chemically reactive ingredients in liquid systems, in particular in aqueous systems.

Phthalimidoperoxoalkanoic acids, e.g., 6-phthalimidoperoxohexanoic acid (PAP), are highly efficient bleaching agents, but they are especially unstable chemically in traditional liquid detergent formulations. In most cases, they decompose completely within a few days in such formulations. Even if these liquid agents are freed of possible reactants of peroxocarboxylic acid, such as unsaturated compounds, aldehydes, amines, chloride, etc., they nevertheless decompose in the presence of surfactants, even if the latter are not subject to oxidative attack. The reason for this may be the fact that although phthaloimidoperoxoalkanoic acids are stable in the form of only slightly water-soluble solids, they dissolve in the presence of surfactants, are highly reactive in dissolved form and decompose via a bimolecular reaction, splitting off singlet oxygen, and also by hydrolysis to form phthalimidoalkanoic acid and H₂O₂. The latter, however, has practically no bleaching activity at low washing temperatures and in the concentrations that occur, so that the bleaching effect of the agent is lost during storage as a result.

There have been various proposals for solving the problem of lack of stability of peroxocarboxylic acids by means of a coating. For example, European Patent EP 0 510 761 B1 describes a coated granular bleaching agent product, which has as its coating material paraffin with a melting point in the range of 40° C. to 50° C. in mixture with certain additives selected from ethylene/vinyl acetate copolymers, hydrogenated colophony methyl esters, ethyl acrylate/2-ethylhexyl acrylate copolymers and mixtures thereof. European Patent EP 0 436 971 A2 discloses coated particles having 45-65 wt % of a solid core containing bleaching agent and 35-50 wt % of a coating layer which contains paraffin wax with a melting point in the range of 40° C. to 50° C. Imidoperoxocarboxylic acids are not listed there as bleaching agents. However, it is found that applying coating materials by no means leads to an increase in the stability of imidoperoxocarboxylic acids in particular. A coating, even with chemically inert materials, often even leads to destabilization of PAP. A coating that should be soluble when using the agent containing the coated particles is usually not completely diffusion-resistant to water in an aqueous product. Therefore, such a coating may suppress the dissolution of PAP but not suppress its hydrolysis to H₂O₂.

There have also been various proposals for solving this problem in which not all ingredients desired for a good washing result and/or cleaning result are to be incorporated into a liquid agent simultaneously but instead the user of the agent is provided with several components which the user should combine shortly before or during the washing operation and/or cleaning operation and which contain only ingredients that are compatible with one another and are used jointly only under the use conditions. Joint dosing of several components, however, is often perceived by the user as being too complex in comparison with dosing just a single liquid agent.

### DESCRIPTION OF THE INVENTION

Consequently, there is still the problem of providing a liquid agent that is stable in storage and also contains as many ingredients as possible that are required to achieve a good washing result and/or cleaning result, even those that are incompatible with one another.

The subject matter of the present invention, which seeks to make a contribution in this regard is a particular imidoperoxocarboxylic acid having a coating of paraffin.

If the imidoperoxocarboxylic acid is not in solid form at room temperature, it may be finished in a known way using carrier materials in particulate form; preferably, however, an imidoperoxocarboxylic acid that is solid at room temperature is used. For example, 4-phthalimidoperoxobutanoic acid, 5-phthalimidoperoxopentanoic acid, 6-phthalimidoperoxohexanoic acid, 7-phthalimidoperoxoheptanoic acid, N,N′-terephthaloyidi-6-aminoperoxohexanoic acid and mixtures thereof may be considered. The preferred peracids include the phthalimidoperoxoalkanoic acids, in particular 6-phthalimidoperoxohexanoic acid (PAP). The core to be coated preferably comprises imido-peroxocarboxylic acid; it is free of surfactants in any case.

The imidoperoxocarboxylic acid core is coated with paraffin wax according to the invention. Paraffin wax is in general a complex substance mixture without a sharp melting point. For the characterization, its melting range is usually determined by differential thermal analysis (DTA) as described in The Analyst, 87 (1962), 420 and/or its solidification point is determined. This is understood to be the temperature at which the molten material is converted from the liquid state to the solid state by gradual cooling. Waxes which solidify in the range of 20° C. to 70° C. are preferably used. It is important to note here that even paraffin wax mixtures that appear to be solid at room temperature may contain various amounts of liquid paraffin. Especially preferred paraffin wax mixtures have a liquid content of at least 50 wt % at 40° C., in particular 55 wt % to 80 wt %, and have a liquid content of at least 90 wt % at 60° C. It is also preferable if the paraffins contain the least possible amount of volatile fractions. Preferred paraffin waxes contain less than 1 wt %, in particular less than 0.5 wt %, of fractions vaporizable at 110° C. and normal pressure. Paraffin waxes that are especially usable according to the invention may be acquired, e.g., under the brand names Lunaflex® from the company Fuller and Deawax® from DEA Mineralöl AG. Especially preferred paraffin waxes include those that melt in the range of 40° C. to 65° C., in particular from more than 50° C. to 60° C.

Paraffin is preferably applied to particulate imidoperoxocarboxylic acid in amounts such that coated imidoperoxocarboxylic acid particles comprise 2 wt % to 30 wt %, in particular 5 wt % to 25 wt % and especially preferably 7.5 wt % to 20 wt % of the coating material. The diameters of the coated peroxocarboxylic acid particles are preferably in the range from 100 μm to 2000 μm, in particular from 200 μm to 1600 μm; therefore, imidoperoxo-carboxylic acid material having more finely divided particles accordingly is used as the starting material and then coated with the paraffin. To produce the imidoperoxocarboxylic acid particles coated according to the invention, it is preferable to proceed by spraying a fluidized bed of the imidoperoxocarboxylic acid particles to be coated with a melt or, if necessary, a preferably aqueous emulsion, dispersion or slurry of the paraffin, removing the water, if present, by evaporation and/or solidifying the molten coating material by cooling and discharging the coated imidoperoxocarboxylic acid particles from the fluidized bed in basically the usual manner. In the inventive coating with the paraffin wax, melt coating is preferred, in which the paraffin is heated to a temperature 5° C. to 40° C. above its melting point and applied to particles of imidoperoxocarboxylic acid, which are at a temperature below the solidification point of paraffin. They are preferably cooled by the fluidizing agent, which is then at a suitably low temperature, so that the paraffin wax solidifies on the imidoperoxocarboxylic acid particles. The additives in the paraffin coating, as specified in EP 0 510 761, are thus omitted.

A paraffin-coated imidoperoxocarboxylic acid particle according to the present invention is preferably used to produce liquid detergents or cleaning agents containing surfactant and water.

The pH of inventive liquid agents is preferably between 2 and 6, in particular between 3 and 5.5, and especially preferably between 3.5 and 5. Water may be present in the inventive agents, if desired, in amounts up to 90 wt %, in particular 20 wt % to 75 wt %; however, it is also possible to go above or below these ranges, if necessary.

The imidoperoxocarboxylic acid content in the inventive agents preferably amounts to 1 wt % to 25 wt %, in particular 2 wt % to 20 wt % and especially preferably 3 wt % to 15 wt %.

In addition to water, surfactant and the coated imidoperoxocarboxylic acid particles, an inventive liquid detergent or cleaning agent may contain all the ingredients conventionally used in such agents, such as solvents, builders, enzymes and other additives such as soil repellants, thickeners, coloring agents and perfumes or the like.

In a preferred embodiment, it contains nonionic surfactants and/or organic solvents and optionally anionic surfactants, cationic surfactants and/or amphoteric surfactants.

The anionic surfactants used are preferably surfactants of the sulfonate type, alk(en)yl sulfates, alkoxylated alk(en)yl sulfates, ester sulfonates and/or soaps.

Preferred surfactants of the sulfonate type used here include C₉-C₁₃ alkylbenzenesulfonates, olefin sulfonates, i.e., mixtures of alkenesulfonates and hydroxyalkanesulfonates and disulfonates, such as those obtained from C₁₂-C₁₈ monoolefins with a terminal or internal double bond by sulfonation with gaseous sulfur trioxide and subsequent alkaline or acidic hydrolysis of the sulfonation products.

The preferred alk(en)yl sulfates are the alkali salts and in particular the sodium salts of sulfuric acid hemiesters of C₁₀-C₁₈ fatty alcohols, e.g., from coco fatty alcohol, tallow fatty alcohol, lauryl alcohol, myristyl alcohol, cetyl alcohol or stearyl alcohol or C₈-C₂₀ oxo alcohols and the hemiesters of secondary alcohols of this chain length. In addition, alk(en)yl sulfates of the aforementioned chain length containing a synthetic linear alkyl radical produced on a petrochemical basis are also preferred. Of technical interest in washing, C₁₂-C₁₆ alkyl sulfates and C₁₂-C₁₅ alkyl sulfates as well as C₁₄-C₁₅ alkyl sulfates and C₁₄-C₁₆ alkyl sulfates are especially preferred. Suitable anionic surfactants also include 2,3-alkyl sulfates, which can be obtained as commercial products under the brand name DAN® from Shell Oil Company, for example.

Also suitable are the sulfuric acid monoesters of linear or branched C₇-C₂₁ alcohols ethoxylated with 1 to 6 mol ethylene oxide, e.g., 2-methyl-branched C₉-C₁₁ alcohols with an average of 3.5 mol ethylene oxide (EO) or C₁₂-C₁₈ fatty alcohols with 1 to 4 EO. They are generally used in detergents only in relatively small amounts, e.g., in amounts of 0 to 5 wt %, due to their high foaming behavior.

The esters of α-sulfofatty acids (ester sulfonates), e.g., the α-sulfonated methyl esters of hydrogenated coco fatty acids, palm kernel fatty acids or tallow fatty acids, are also suitable.

Soaps in particular may be considered as additional anionic surfactants. Saturated fatty acid soaps are suitable in particular, such as the salts of lauric acid, myristic acid, palmitic acid, stearic acid, hydrogenated erucaic acid and behenic acid as well as in particular soap mixtures derived from natural fatty acids, e.g., coco fatty acids, palm kernel fatty acids or tallow fatty acids. Soap mixtures comprised of up to 50 wt % to 100 wt % saturated C₁₂-C₂₄ fatty acid soaps and 0 to 50 wt % oleic acid soap are preferred in particular.

Another class of anionic surfactants is the class of ether carboxylic acids that are accessible by reaction of fatty alcohol ethoxylates with sodium chloroacetate in the presence of basic catalysts. They have the general formula: RO—(CH₂—CH₂O)ₚ—CH₂−COOH, where R=C₁-C₁₈ and p=0, 1 to 20. Ether carboxylic acids are insensitive to water hardness and have excellent surfactant properties.

Cationic surfactants contain the high-molecular hydrophobic radical, which is responsible for the surface activity in the cation on dissociation in aqueous solution. The most important representatives of cationic surfactants are the quaternary ammonium compounds of the general formula (R¹R²R¹R⁴N⁺)X⁻, where R¹ stands for C₁-C₈ alk(en)yl, R² to R⁴ independently of one another stand for CₙH₂ₙ₊₁₋ₚ₋ₓ—(Y¹(CO)R⁵)ₚ—(Y²H)ₓ, where n stands for integers, not including 0, and p and x stand for integers or 0. Y¹ and Y² independently of one another stand for O, N or NH. R⁵ denotes a C₃-C₂₃ alk(en)yl chain. X is a counterion, which is preferably selected from the group of alkyl sulfates and alkyl carbonates. Cationic surfactants in which the nitrogen group is substituted with two long acyl radicals and two short alk(en)yl radicals are especially preferred.

Amphoteric or ampholytic surfactants have several functional groups which may ionize in aqueous solution and impart an anionic or cationic character to the compounds, depending on the conditions of the medium. In the vicinity of the isoelectric point, the amphoteric surfactants form internal salts, so they may be insoluble or sparingly soluble in water. Amphoteric surfactants are subdivided into ampholytes and betaines, the latter being present in solution as zwitterions. Ampholytes are amphoteric electrolytes, i.e., compounds which have both acidic and basic hydrophilic groups and thus behave as an acid or base, depending on the conditions. Compounds with the atomic group R₃N⁺—CH₂—COO⁻ having typical properties of zwitterions are known as betaines.

As nonionic surfactants, preferably alkoxylated and/or propoxylated alcohols, in particular primary alcohols preferably with 8 to 18 carbon atoms and an average of 1 to 12 mol ethylene oxide (EO) and/or 1 to 10 mol propylene oxide (PO) are used per mol alcohol. C₈-C₁₆ alcohol alkoxylates are especially preferred, advantageously ethoxylated and/or propoxylated C₁₀-C₁₅ alcohol alkoxylates, in particular C₁₂-C₁₄ alcohol alkoxylates with a degree of ethoxylation between 2 and 10, preferably between 3 and 8 and/or a degree of propoxylation between 1 and 6, preferably between 1.5 and 5. The stated degrees of ethoxylation and propoxylation are statistical means, which may be an integer or a fraction for a specific product. Preferred alcohol ethoxylates and propoxylates have a narrow homolog distribution (narrow range ethoxylates/propoxylates, NRE/NRP). In addition to these nonionic surfactants, fatty alcohols with more than 12 EO may also be used. Examples include (tallow) fatty alcohols with 14 EO, 16 EO, 20 EO, 25 EO, 30 EO or 40 EO.

In addition, alkyl glycosides of the general formula RO(G)ₓ may be used as additional nonionic surfactants, e.g., as compounds, in particular with anionic surfactants, wherein R denotes a primary linear or methyl-branched aliphatic radical, in particular with methyl branching in position 2 with 8 to 22 carbon atoms, preferably 12 to 18 carbon atoms, and G is the symbol standing for a glycose unit with 5 or 6 carbon atoms, preferably glucose. The degree of oligomerization x, which indicates the distribution of monoglycosides and oligoglycosides, is any number between 1 and 10; x is preferably 1.1 to 1.4.

Another class of nonionic surfactants that are preferably used and are used either as the only nonionic surfactant or in combination with other nonionic surfactants, in particular together with alkoxylated fatty alcohols and/or alkyl glycosides includes alkoxylated, preferably ethoxylated or ethoxylated and propoxylated fatty acid alkyl esters, preferably with 1 to 4 carbon atoms in the alkyl chain, in particular fatty acid methyl esters such as those which are described in Japanese Patent Application JP-A-58/217 598 or which are preferably produced by the method described in International Patent Application WO-A-90/13533. C₁₂-C₁₈ fatty acid methyl esters with an average of 3 to 15 EO, in particular with an average of 5 to 12 EO are especially preferred.

Nonionic surfactants of the amine oxide type, e.g., N-cocoalkyl-N,N-dimethylamine oxide and N-tallow alkyl-N,N-dihydroxyethylamine oxide and fatty acid alkanolamides may also be suitable as nonionic surfactants. The amount of these nonionic surfactants is preferably no more than that of the ethoxylated fatty alcohols, in particular no more than half thereof.

So-called gemini surfactants may be considered as additional surfactants. These include in general compounds having two hydrophilic groups and two hydrophobic groups per molecule. These groups are usually separated from one another by a so-called spacer. This spacer is usually a carbon chain, which should be long enough so that the hydrophilic groups have a sufficient spacing to be able to act independently of one another. Such surfactants are characterized in general by an unusually low critical micelle concentration and the ability to greatly reduce the surface tension of water. In exceptional cases, however, the term “gemini surfactants” is understood to refer not only to dimeric surfactants but also trimeric surfactants.

Suitable gemini surfactants include, for example, sulfated hydroxy mixed ethers according to German Patent Application DE-A-43 21 022 or dimeric alcohol bis-sulfates and trimeric alcohol tris-sulfates and ether sulfates according to International Patent Application WO-A-96/23768. End group-capped dimeric and trimeric mixed ethers according to German Patent Application DE-A-195 13 391 are characterized by their bifunctionality and multifunctionality in particular. The aforementioned end group-capped surfactants have good wetting properties and are low foaming, so they are suitable in particular for use in machine washing or cleaning methods.

However, gemini polyhydroxy fatty acid amides or polyhydroxy fatty acid amides as described in the International Patent Applications WO-A-95/19953, WO-A-95/19954 and WO95-A/19955 may also be used.

The amount of surfactants contained in the inventive agents is preferably 0.1 wt % to 50 wt %, in particular 10 wt % to 40 wt % and especially preferably 20 wt % to 70 wt %. Preferably only mixtures of anionic and nonionic surfactants are used.

Preferably polydiols, ethers, alcohols, ketones, amides and/or esters in amounts of 0 to 90 wt %, preferably 0.1 to 70 wt %, in particular 0.1 to 60 wt %, each based on the amount of water present, may be used as the organic solvents. Low-molecular polar substances such as methanol, ethanol, propylene carbonate, acetone, acetonylacetone, diacetone alcohol, ethyl acetate, 2-propanol, ethylene glycol, propylene glycol, glycerol, diethylene glycol, dipropylene glycol monomethyl ether and dimethylformamide and/or mixtures thereof are preferred.

Enzymes that may be used include in particular those from the class of hydrolases such as proteases, esterases, lipases and/or lipolytic enzymes, amylases, cellulases and/or other glycosyl hydrolases and mixtures of the aforementioned enzymes. All these hydrolases contribute toward removal of spots in the wash, e.g., spots containing protein, fat or starch and graying. Cellulases and other glycosyl hydrolases may contribute toward color retention by elimination of pilling and microfibrils and may contribute toward an increase in softness of the textile. Oxidoreductases may also be used for bleaching and/or inhibiting dye transfer.

Enzymatic active ingredients obtained from bacterial strains or fungi such as Bacillus subtilis, Bacillus licheniformis, Streptomyces griseus and Humicola insolens are especially suitable. Proteases of the subtilisin type and in particular proteases obtained from Bacillus lentus are preferred for use here. Of particular interest here are enzyme mixtures, e.g., of protease and amylase or protease and lipase and/or lipolytic enzymes or protease and cellulase or cellulase and lipase and/or lipolytic enzymes or protease, amylase and lipase and/or lipolytic enzymes or protease, lipase and/or lipolytic enzymes and cellulase, but in particular mixtures containing protease and/or lipases and/or mixtures with lipolytic enzymes. Examples of such lipolytic enzymes include the known cutinases. Peroxidases or oxidases have also proven suitable in some cases. Suitable amylases include in particular α-amylases, isoamylases, pullulanases and pectinases. Preferably cellobiohydrolases, endoglucanases and β-glucosidases, which are also known as cellobiases and/or mixtures thereof, are used as cellulases. Since the various types of cellulase differ in their CMCase and avicelase activities, the desired activities can be established through targeted mixtures of the cellulases.

The amount of enzymes and/or enzyme mixtures may be approximately 0.1 wt % to 5 wt %, preferably 0.1 to approx. 3 wt %, for example. They are preferably used in the inventive agents, prepared in particulate form.

Additional detergent ingredients that may be present include builders, cobuilders, soil repellants, alkaline salts such as foam inhibitors, complexing agents, enzyme stabilizers, graying inhibitors, optical brighteners and UV absorbers.

Builders that may be used include, for example, finely crystalline synthetic zeolite containing bound water, preferably zeolite A and/or P. For example, zeolite MAPO (commercial product of the company Crosfield) is especially preferred as zeolite P. However, zeolite X and mixtures of A, X and/or P are also suitable. Of particular interest is a cocrystalline sodium/potassium-aluminum silicate of zeolite A and zeolite X, which is commercially available as VEGOBOND AX® (commercial product of the Condea company). The zeolite may preferably be used as a spray-dried powder. For the case when the zeolite is used as a suspension, it may contain small additives of nonionic surfactants as stabilizers, e.g., 1 wt % to 3 wt %, based on zeolite, ethoxylated C₁₂-C₁₈ fatty alcohols with 2 to 5 ethylene oxide groups, C₁₂-C₁₄ fatty alcohols with 4 to 5 ethylene oxide groups or ethoxylated isotridecanols. Suitable zeolites have an average particle size of less than 10 μm (volume distribution; measurement method: Coulter counter) and preferably contain 18 wt % to 22 wt %, in particular 20 wt % to 22 wt % bound water. In addition, phosphates may also be used as builder substances.

Suitable substitutes and/or partial substitutes for phosphates and zeolites are crystalline layered sodium silicates of the general formula NaMSiₓO₂ₓ₊₁.yH₂O, where M denotes sodium or hydrogen, x is a number from 1.9 to 4, y is a number from 0 to 20, and preferred values for x are 2, 3 or 4. Such crystalline phylosilicates are described in European Patent Application EP-A-0 164 514, for example. Preferred crystalline phylosilicates of the formula given above are those in which M stands for sodium and x assumes the values 2 or 3. In particular both β- and δ-sodium disilicates Na₂Si₂O₅.yH₂O are preferred, where 13-sodium disilicate can be obtained by the method described in International Patent Application WO-A-91/08171, for example.

The preferred builder substances also include amorphous sodium silicates with a modulus of Na₂O:SiO₂ of 1:2 to 1:3.3, preferably from 1:2 to 1:2.8 and in particular from 1:2 to 1:2.6, which dissolve with a delay and have secondary washing properties. The delay in dissolving in comparison with traditional amorphous sodium silicates may be achieved in various ways, e.g., by surface treatment, compounding, compacting/compressing or overdrying. Within the scope of this invention, the term “amorphous” is also understood to mean “amorphous to x-rays.” This means that in x-ray diffraction experiments, the silicates do not yield sharp x-ray reflexes such as those typical of crystalline substances, but at most have one or more maximums of scattered x-ray radiation having a width of several degree units of the diffraction angle. However, if the silicate particles yield blurred or even sharp diffraction maximums in the electron diffraction experiments, it may still lead to especially good builder properties. This is to be interpreted as meaning that the products have microcrystalline regions 10 nm in size up to several hundred nm in size, values up to max. 50 nm and in particular up to max. 20 nm being preferred. Such so-called x-ray amorphous silicates, which also have a delayed dissolving property in comparison with traditional water glasses, are described in German Patent Application DE-A-44 00 024, for example. Compressed/compacted amorphous silicates, compounded amorphous silicates and overdried x-ray-amorphous silicates are preferred in particular.

Use of the generally known phosphates as builder substances is also possible if such a use should not be avoided for ecological reasons. In particular the sodium salts of orthophosphates, pyrophosphates and in particular tripolyphosphates are suitable. Their amount is generally no more than 25 wt %, preferably no more than 20 wt %, each based on the finished agent. In some cases, it has been found that tripolyphosphates in particular lead to a synergistic improvement in secondary detergency in even small amounts up to max. 10 wt %, based on the finished agent, in combination with other builder substances. Preferred amounts of phosphates are less than 10 wt %, especially preferably 0 wt %.

Organic builder substances that can be used as cobuilders include the polycarboxylic acids that may be used in the form of their sodium salts, where polycarboxylic acids are understood to be carboxylic acids having more than one acid function. Examples include citric acid, adipic acid, succinic acid, glutaric acid, malic acid, tartaric acid, maleic acid, fumaric acid, saccharic acids, aminocarboxylic acids, nitrilotriacetic acid (NTA) and derivatives thereof as well as mixtures thereof. Preferred salts include the salts of polycarboxylic acids such as citric acid, adipic acid, succinic acid, glutaric acid, tartaric acid, saccharic acids and mixtures thereof.

The acids may also be used per se. In addition to their builder effect, the acids typically also have the property of being an acidifying component and thus also serve to adjust a lower and milder pH of detergents or cleaning agents. Citric acid, succinic acid, glutaric acid, adipic acid, gluconic acid and any mixtures thereof can be mentioned here in particular. Other acidifying agents that may be used include known pH regulators such as sodium bicarbonate and sodium bisulfate.

Additional polymeric polycarboxylates are suitable as builders; these include, for example, the alkali metal salts of polyacrylic acid or polymethacrylic acid, e.g., those with a relative molecular weight of 500 g/mol to 70,000 g/mol.

In the sense of the present document, the molecular weights given for polymeric polycarboxylates are weight-average molecular weights M_{w} of the respective acid form, which have been determined essentially by gel permeation chromatography (GPC) using a UV detector. The measurement was performed against an external polyacrylic acid standard, which yields realistic molecular weight values because of its structural relationship to the polymers investigated. This information deviates significantly from the molecular weight data in which polystyrene sulfonic acids are used as the standard. The molecular weights measured against polystyrene sulfonic acids are usually much higher than the molecular weights given in this document.

Suitable polymers include in particular polyacrylates, which preferably have a molecular weight of 2,000 g/mol to 20,000 g/mol. Because of their superior solubility, the short-chain polyacrylates having molecular weights of 2,000 g/mol to 10,000 g/mol and especially preferably from 3,000 g/mol to 5,000 g/mol may in turn be preferred from this group.

Suitable polymers may also include substances partially or entirely comprising units of vinyl alcohol or derivatives thereof.

In addition, copolymeric polycarboxylates, in particular those of acrylic acid with methacrylic and those of acrylic acid or methacrylic with maleic acid are also suitable. Copolymers of acrylic acid with maleic acid containing 50 wt % to 90 wt % acrylic acid and 50 wt % to 10 wt % maleic acid have proven to be especially suitable. Their relative molecular weight, based on free acids, is generally 2,000 g/mol to 70,000 g/mol, preferably 20,000 g/mol to 50,000 g/mol and in particular 30,000 g/mol to 40,000 g/mol. The (co)polymeric polycarboxylates may be used either as an aqueous solution or preferably as a powder.

To improve the water solubility, these polymers may also contain allylsulfonic acids, e.g., allyloxybenzenesulfonic acid and methallylsulfonic acid as monomers.

Also especially preferred are biodegradable polymers of more than two different monomer units, e.g., those that contain salts of acrylic acid and maleic acid as well as vinyl alcohol and/or vinyl alcohol derivatives as monomers according to DE-A-43 00 772 or containing salts of acrylic acid and 2-alkylallylsulfonic acid as well as sugar derivatives and monomers according to DE-C-42 21 381.

Other preferred copolymers include those that are described in German Patent Applications DE-A-43 03 320 and DE-A-44 17 734 and that preferably have acrolein and acrylic acid/acrylic acid salts and/or acrolein and vinyl acetate as monomers.

Additional suitable builder substances include polyacetals, which can be obtained by reaction of dialdehydes of polyol carboxylic acids having 5 to 7 carbon atoms and at least three hydroxyl groups, e.g., as described in European Patent Application EP-A-0 280 223. Preferred polyacetals are obtained from dialdehydes such as glyoxal, glutaraldehyde, terephthalaldehyde and mixtures thereof and from polyol carboxylic acids such as gluconic acid and/or glucoheptonic acid.

Other suitable organic builder substances include dextrins, e.g., oligomers and/or polymers of carbohydrates that can be obtained by partial hydrolysis of starches. The hydrolysis may be performed according to conventional methods, e.g., acid catalyzed or enzyme catalyzed. These are preferably hydrolysis products having average molecular weights in the range of 400 g/mol to 500,000 g/mol. A polysaccharide with one dextrose equivalent (DE) in the range of 0.5 to 40, in particular from 2 to 30 is preferred, where DE is a conventional measure for the reducing effect of a polysaccharide in comparison with dextrose, which has a DE of 100. Both maltodextrins with a DE between 3 and 20 and dry glucose syrups with a DE between 20 and 37 as well as so-called yellow dextrins and white dextrins with higher molecular weights in the range of 2,000 g/mol to 30,000 g/mol can also be used. A preferred dextrin is described in British Patent Application 9,419,091.

The oxidized derivatives of such dextrins are their reaction products with oxidizing agents that are capable of oxidizing at least one alcohol function of the saccharide ring to the carboxylic acid function. Such oxidized dextrins and methods of synthesizing same are known from the European Patent Applications EP-A-0 232 202, EP-A-0 427 349, EP-A-0 472 042 and EP-A-0 542 496 and the International Patent Applications WO-A-92/18542, WO-A-93/08251, WO-A-93/16110, WO-A-94/28030, WO-A-95/07303, WO-A-95/12619 and WO-A-95/20608, for example. An oxidized oligosaccharide according to German Patent Application DE-A-196 00 018 is also suitable. A product oxidized on C₆ of the saccharide ring may be especially advantageous.

Oxydisuccinates and other derivatives of disuccinates, preferably ethylenediaminedisuccinate are additional suitable cobuilders. Ethylene-diamine-N,N′-disuccinate (EDDS), synthesis of which is described in U.S. Pat. No. 3,158,615, for example, is preferably used in the form of its sodium or magnesium salts. In this context, glycerol disuccinates and glycerol trisuccinates as described in the US patents U.S. Pat. No. 4,524,009, U.S. Pat. No. 4,639,325, European Patent Application EP-A-0 150 930 and Japanese Patent Application JP-A-93/339 896, for example, are also preferred. Suitable amounts for use are 3 wt % to 15 wt % in formulations containing zeolite and/or silicate.

Other usable organic cobuilders include, for example, acetylated hydroxycarboxylic acids and/or the salts thereof, which may optionally also be present in lactone form and which have at least four carbon atoms and at least one hydroxyl group plus max. two acid groups. Such cobuilders are described in International Patent Application WO 95/20029, for example.

In addition, the agents may also contain components, so-called soil repellants, which have a positive influence on the removability of oil and fat from textiles. This effect is especially apparent when a textile that has already previously been washed several times with the inventive detergent containing this oil- and fat-dissolving component becomes soiled. The preferred oil and fat-dissolving components include, for example, nonionic cellulose ethers such as methylcellulose and methylhydroxypropylcellulose with a methoxyl group content of 15 wt % to 30 wt % and a hydroxypropyl group content of 1 wt % to 15 wt %, each based on nonionic cellulose ether, and the polymers of phthalic acid and/or terephthalic acid known from the state of the art and/or derivatives thereof, in particular polymers of ethylene terephthalates and/or polyethylene glycol terephthalates or anionically and/or nonionically modified derivatives thereof. Of these, the disulfonated derivatives of phthalic acid and terephthalic acid polymers are especially preferred.

When used in machine washing processes, it may be advantageous to add the usual foam inhibitors to the agents. Suitable foam inhibitors include, for example, soaps of natural or synthetic origin which contain a large amount of C₁₈-C₂₄ fatty acids. Suitable nonsurfactant foam inhibitors include, for example, organopolysiloxanes and mixtures thereof with microfine, optionally silanized silicic acid and paraffins, waxes, microcrystalline waxes and mixtures thereof with silanized silicic acid or bistearylethylenediamine. Mixtures of different foam inhibitors may also be used to advantage, e.g., those of silicones, paraffins or waxes.

As complexing agents and/or as stabilizers in particular for enzymes that are sensitive to heavy metals ions, the salts of polyphosphonic acids may be considered. The sodium salts of 1-hydroxyethane-1,1-diphosphonate as well as diethylenetriaminepentamethylenephosphonate or ethylenediaminetetra-methylenephosphonates in amounts of 0.1 wt % to 5 wt % of the agent, for example, are preferably used here. Nitrogen-free complexing agents are preferred.

Graying inhibitors have the task of keeping the dirt released from the fiber suspended in the bath and preventing reuptake of the dirt. Water-soluble colloids usually of an organic nature are suitable for this purpose, e.g., the water-soluble salts of (co)polymeric carboxylic acids, glue, gelatin, salts of ether carboxylic acids or ether sulfonic acids of starch or cellulose or salts of acidic sulfuric acid esters of cellulose or starch. Water-soluble polyamides containing acid groups are also suitable for this purpose. In addition, soluble starch preparations and starch products other than those mentioned above may also be used, e.g., degraded starch, aldehyde starches, etc. Polyvinylpyrrolidone may also be used. However, cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose and mixtures thereof as well as polyvinylpyrrolidone are preferred, e.g., in amounts of 0.1 wt % to 5 wt %, based on the agent.

The agents may contain optical brighteners, e.g., derivatives of diaminostilbenedisulfonic acid and/or the alkali metal salts. For example, the salts of 4,4′-bis(2-anilino-4-morpholino-1,3,5-triazinyl-6-amino)silbene-2,2′-disulfonic acid or similarly structured compounds having instead of the morpholino group a diethanolamino group, a methylamino group, an anilino group or a 2-methoxyethylamino group are also suitable. In addition, brighteners of the substituted diphenylstyryl type may also be present, e.g., the alkali salts of 4,4′-bis(2-sulfostyryl)diphenyl, 4,4′-bis(4-chloro-3-sulfostyryl)-diphenyl or 4-(4-chlorostyryl)-4′-(2-sulfostyryl)diphenyl. Mixtures of the afore-mentioned brighteners may also be used.

In addition, UV absorbers may also be used. These are compounds with a marked absorbency for ultraviolet radiation, which as light protectants (UV stabilizer) contribute toward an improvement in the lightfastness of dyes and pigments as well as textile fibers and also protect the skin of the wearer of textile products from the incident UV radiation penetrating through the textile. In general, the compounds that are effective through radiationless deactivation include the derivatives of benzophenone, whose substituents such as hydroxyl groups and/or alkoxy groups are usually in position 2 and/or 4. In addition, substituted benzotriazoles are also suitable, as are acrylates (cinnamic acid derivatives) with a phenyl substituent in position 3, optionally with cyano groups in position 2, salicylates, organic nickel complexes and natural substances such as umbelliferone and endogenous urocanic acid. In a preferred embodiment, the UV absorbers absorb UVA and UVB radiation and optionally UVC radiation and reflect it back with wavelengths of blue light, so that they also have the effect of an optical brightener. Preferred UV absorbers also include the UV absorbers disclosed in European Patent Applications EP-A-0 374 751, EP-A-0 659 877, EP-A-0 682 145, EP-A-0 728 749 and EP-A-0 825 188 such as triazine derivatives e.g., hydroxyaryl-1,3,5-triazine, sulfonated 1,3,5-triazine, o-hydroxyphenylbenzenetriazole and 2-aryl-2H-benzotriazole as well as bis(anilinotriazinylamino)stilbenedisulfonic acid and derivatives thereof. Ultraviolet radiation-absorbing pigments such as titanium dioxide may also be used as the UV absorbers.

The agents may, if desired, also contain thickeners and anti-redeposition agents as well as viscosity regulators, e.g., polyacrylates, polycarboxylic acids, polysaccharides and derivatives thereof, polyurethanes, polyvinylpyrrolidones, castor oil derivatives, polyamine derivatives such as quaternated and/or ethoxylated hexamethylenediamine as well as any mixtures thereof. Electrolytes may also be used to increase the viscosity of the inventive liquid agents, but the use of magnesium sulfate is especially preferred. Magnesium sulfate may be present in the inventive agents in amounts up to 30 wt %, if desired. Preferred amounts in the range of 3 wt % to 20 wt %, in particular in the range of 6 wt % to 10 wt % are preferred, and mixtures of magnesium sulfate with sodium sulfate and/or potassium sulfate may also be used. In measurements with a Brookfield viscometer at a temperature of 20° C. and a shear rate of 20 min⁻¹, preferred agents have a viscosity between 100 mPas and 10,000 mPas.

The agents may contain additional typical detergent and cleaning agent ingredients such as perfumes and/or coloring agents, wherein such coloring agents which have little or no coloring effect on the textiles to be washed are preferred. Preferred quantity ranges for the totality of the coloring agents used are less than 1 wt %, preferably less than 0.1 wt %, based on the agent. The agents may optionally also contain white pigments such as TiO₂.

Preferred agents have densities of 0.5 g/cm³ to 2.0 g/cm³, in particular 0.7 g/cm³ to 1.5 g/cm³. The density difference between the coated imidoperoxocarboxylic acid particles and the liquid phase of the agent is preferably no more than 10% of the density of one of the two and is in particular so low that the coated imidoperoxocarboxylic acid particles and preferably also optionally other solid particles contained in the agents are suspended in the liquid phase.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

### EXAMPLES

### Example 1

### Production of PAP Granules Coated According to the Invention (E)

Commercially available 6-phthalimidoperoxohexanoic acid granules EURECO® granules from Solvay Solexis Bussi, Italy were used as the core. The granules were first screened to particle sizes of 0.6 mm to 1.2 mm. One part was used as the Comparative Example (V) and a second part was coated with a coating of paraffin, melting point 57° C. to 60° C. (Merck) in an amount of 20 wt %, based on the core material, in a laboratory Aeromatic Fielder fluidized bed system, which was equipped as a Wurster coater with heatable bottom spray nozzle.

### Example 2

### Production of an Inventive Liquid Detergent

An inventive liquid all-purpose detergent (with granules E from Example 1) and a comparative recipe (with granules V) of the following compositions (each in wt %) was prepared:

16.5% sodium alkylbenzenesulfonate (Cognis)
10% fatty alcohol ethoxylated with 7 EO (Dehydrol® LT 7, Cognis)
1% complexing agent (Sequion® 10H 60, Polygon Chemie)
3% trisodium citrate
8% sodium sulfate
3% granules E and/or granules V
0.25% xanthan gum TGCS (Jungbunzlauer Xanthan GmbH)
1% perfume
0.1% silicone foam suppressant (Wacker Chemie) to 100%: water

Production was performed by placing the water in a stirred container and then adding the xanthan. After swelling of the xanthan (30 minutes), the sulfate was added. Then the surfactants and other raw materials were added while stirring. The pH was adjusted to 5.0±0.2 with concentrated NaOH.

### Example 3

### Evaluation of the Stability of the Bleaching Agent Granules in Storage

The stability of the bleaching agent granules in storage was determined by storing samples of the detergents from Example 2 at a constant storage temperature of 35° C. The initial PAP content and the contents after 1, 2, 4 and 8 weeks were determined with the help of an iodometric titration at a temperature of 0° C. The values thus obtained are summarized in the following table, where the PAP contents are given in %, based on the starting value.

| Agent with | 0 weeks | 1 week | 2 weeks | 4 weeks | 8 weeks |
|---|---|---|---|---|---|
| V | 100 | 89 | 72.5 | 44 | 16 |
| E | 100 | 99 | 91 | 69 | 38 |

It can be seen here that granules E coated according to the invention have a much better stability in storage than uncoated granules V.

What is claimed:

1. A particle comprising a core and a coating surrounding the core, the core comprising an imidoperoxocarboxylic acid and being free of any surfactant, and the coating comprising paraffin.

2. The particle of claim 1, wherein the imidoperoxocarboxylic acid is 4-phthalimidoperoxobutanoic acid, 5-phthalimidoperoxopentanoic acid, 6-phthalimidoperoxohexanoic acid, 7-phthalimidoperoxoheptanoic acid, N,N′-terephthaloyldi-6-aminoperoxohexanoic acid, or a mixture thereof.

3. The particle of claim 1, wherein the coating comprises 2 to 30 percent by weight of the particle.

4. The particle of claims 3, wherein the coating comprises 5 to 25 percent by weight of the particle.

5. The particle of claim 1, wherein the paraffin has a solidification range of 20° C. to 70° C.

6. A method for producing a paraffin-coated imidoperoxocarboxylic acid particle, comprising the steps of:
fluidizing a bed of imidoperoxocarboxylic acid particles;
spraying the fluidized particles with a melt comprising a paraffin;
solidifying the molten paraffin on the particles by cooling; and
discharging the coated particles from the fluidized bed.

7. A method for producing a paraffin-coated imidoperoxocarboxylic acid particle, comprising the steps of:
fluidizing a bed of imidoperoxocarboxylic acid particles;
spraying the fluidized particles with an aqueous emulsion, dispersion, or slurry of a paraffin;
evaporating the water from the sprayed particles; and
discharging the coated particles from the fluidized bed.

8. An aqueous liquid detergent or cleaning agent, comprising a surfactant and the particle of claim 1.

9. The composition of claim 8, comprising 1 to 25 percent by weight of imidoperoxocarboxylic acid.

10. The composition of claim 9, comprising 2 to 20 weight percent of imidoperoxocarboxylic acid.

11. The composition of claim 8, comprising 0.1 to 50 percent by weight of the surfactant.

12. The composition of claim 11, comprising 10 to 40 percent by weight of the surfactant.

13. The composition of claim 8, having a pH of 2 to 6.

14. The composition of claim 13, having a pH 3 and 5.5.

15. The composition of claim 8, wherein the particle and the liquid phase have densities that differ by no more than 10 percent.
